(19) United States
(12) Patent Application Publication
(10) Pub. No.: US 2005/0112530 A1
(43) Pub. Date: May 26, 2005

(54) Computer-implemented method, system and program product for performing branched rollup for shared learning competencies in a learning environment

(75) Inventors: Thomas J. Dinger, Sunnyvale, CA (US); Jonathan T. Zempel, Campbell, CA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/721,630

(22) Filed: Nov. 25, 2003

(51) Int. Cl. G09B 19/00

(52) U.S. Cl. 434/118

(57) ABSTRACT

Under the present invention a hierarchical tree corresponding to the learning environment is provided. When the state of a shared learning competency in the learning environment is changed, branched rollup through the hierarchical tree is performed so that all applicable nodes are rolled up without a node being rolled up more than once. Specifically, when the state of the shared learning competency is changed, control blocks are generated for each predecessor of the “sharing” nodes. The control block for each predecessor identifies the successors (nodes) that must be rolled up before the predecessor itself can be rolled up. Under this methodology, a node will only be rolled up when all necessary successors have been rolled up, thus, preventing repeated rollup of any of the nodes.

### BACKGROUND OF THE INVENTION

1. Field of the Invention

The present invention generally relates to a computer-implemented method, system and program product for performing branched rollup of shared learning competencies in a learning environment. Specifically, the present invention alleviates the various problems that arise when a learning competency is shared throughout multiple branches of a learning environment.

2. Related Art

As computer technology becomes more pervasive, it has become common for learning environments to be implemented in a computerized environment. For example, today a student can take classes, perform assignments, take exams, etc. from the comfort of his/her personal computer. In many instances, the learning environments are delivered via a network such as the Internet so that the student can participate in the class using a web browser or the like. In a typical learning environment, the general entity used to deliver a learning experience to a student is a “learning object.” The simplest type of learning object is an “Activity,” which references a single content page that is to be delivered to the student. Learning objects can also be grouped to form a more complex learning object. One such example of is a “Topic,” which consists of a set (e.g., one or more) of “Activities” that are to be delivered to the student in a particular order. Still yet, another, more complex example of a learning object is a “Course,” which comprises multiple “Topics” and “Activities” arranged in a hierarchical tree. From the simplest “Activity” to the most complex “Course,” any learning object could be the basis for the student gaining a defined skill, obtaining some quantifiable knowledge, acquiring a specific ability or meeting an educational objective. Any of these quantifiable measurements can be generally categorized as a “Learning Competency.” It is also possible for more than one learning object to be the basis for attaining a given competency.

Referring to FIG. 1, an illustrative hierarchical tree 10 corresponding to a learning environment is shown. As depicted, hierarchical tree 10 includes a parent node 12 referred to as “Course,” and two separate branches 14A-B thereunder. Each branch 14A-B includes a child node 16A-B referred to as “Topic 1” and “Topic 2,” and a set of grandchild nodes 18A-D referred to as “Activity 1,” “Activity 2,” “Activity 3” and “Activity 4.” As such, parent node 12 is considered to be a predecessor of child nodes 16A-B and grandchild nodes 18A-D, while child nodes 16A-B are considered to be predecessors of grandchild nodes 18A-D, respectively. Similarly, child nodes 16A-B and grandchild nodes 18A-D are considered to be successors of parent node 12, while grandchild nodes 18A-D are considered to be successors of child nodes 16A-B, respectively.

In any event, because the properties of predecessors depend on the properties of their successors, when the state of a certain learning competency for a learning object (e.g., “Activity 2”) changes for a given student, corresponding information must be communicated up the corresponding branch of hierarchical tree 10. This is concept is known as “information rollup.” Thus, for example, when the state of learning competency 20 is changed, an information rollup should be performed from grandchild node 18B (known as the rollup target) to child node 16A and parent node 12.

Unfortunately, various problems arise when learning competency is shared among multiple nodes or branches of hierarchical tree 10. For example, referring to FIG. 2, a hierarchical tree 22 similar to hierarchical tree 10 is shown. However, in hierarchical tree 22, it can be seen that learning competency 20 is shared by grandchild nodes 18B and 18C of branches 14A-B. When the state of learning competency 20 changes for grandchild node 18B, it should also be changed with respect to grandchild node 18C. Accordingly, information rollup for both branches 14A-B should be performed. However, existing techniques for branched rollups of a shared learning competency either ignore the branched rollup situation, or require nodes to be rolled up more than once for a change in the state of a single learning competency.

For example, although IMS Simple Sequencing (v 1.0) provides a mechanism to define associations between learning objects and competencies, it does not provide a mechanism to handle the branched rollup situation. Another solution is to use a repeated rollup algorithm whereby nodes can be repeatedly rolled up. Using the example in FIG. 2, once the state of learning competency 20 is changed, grandchild node 18B, child node 16A and parent node 12 would be rolled up followed by a rollup of grandchild node 18C, child node 16B and parent node 12. Thus, parent node 12 would be rolled up twice. In either case, various drawbacks are present. For example, if the branched rollup is ignored, incorrect results could be yielded because parent node 12 would not reflect the changes to branch 14B. However, if the repeated rollup algorithm is followed, parent node 12 would be rolled up twice, which could trigger certain error events.

In view of the foregoing, there exists a need for a computer-implemented method, system and program product for performing branched rollup of shared learning competencies in a learning environment. Specifically, a need exists whereby a complete rollup process can be performed when the state of a shared learning competency is changed without any of the nodes being rolled up more than once.

### SUMMARY OF THE INVENTION

In general, the present invention provides a computer-implemented method, system and program product for performing branched rollup of shared learning competencies in a learning environment. Specifically, under the present invention a hierarchical tree corresponding to the learning environment is provided. When the state of a shared learning competency in the learning environment is changed, branched rollup through the hierarchical tree is performed so that all applicable nodes are rolled up without a node being rolled up more than once. Specifically, when the state of the shared learning competency is changed, control blocks are generated for each predecessor of the “sharing” nodes. The control block for each predecessor identifies the successors (nodes) that must be rolled up before the predecessor itself can be rolled up. Under this methodology, a node will only be rolled up when all necessary successors have been rolled up, thus, preventing repeated rollup of any of the nodes.

A first aspect of the present invention provides a computer-implemented method for performing branched rollup for shared learning competencies in a learning environment, comprising: providing a hierarchical tree corresponding to the learning environment, wherein the hierarchical tree includes a parent node, a first branch having a first child node and a first grandchild node, and a second branch having a second child node and a second grandchild node; providing a learning competency in the learning environment that is shared by the first grandchild node and the second grandchild node; performing an information rollup of the first child node upon a change in state of the learning competency, and performing an information rollup of the second child node after performing the information rollup of the first child node; and performing an information rollup of the parent node only after performing the information rollup of the first child node and the information rollup of the second child node.

A second aspect of the present invention provides a computerized system for performing branched rollup for shared learning competencies in a learning environment, comprising: a list compilation system for generating a list of nodes that share a learning competency within a hierarchical tree corresponding to the learning environment; a block generation system for generating control blocks for predecessors of the nodes in the list of nodes, wherein each of the control blocks identifies specific successors of the predecessors for which information rollups must be performed before information rollups of the predecessors can be performed; and a node rollup system for processing the control blocks and performing the information rollups of the predecessors after performing the information rollups of the specific successors.

A third aspect of the present invention provides a computer program product stored on a recordable medium for performing branched rollup for shared learning competencies in a learning environment, which when executed, comprises: program code for generating a list of nodes that share a learning competency within a hierarchical tree corresponding to the learning environment; program code for generating control blocks for predecessors of the nodes in the list of nodes, wherein each of the control blocks identifies specific successors of the predecessors for which information rollups must be performed before information rollups of the predecessors can be performed; and program code for processing the control blocks and performing the information rollups of the predecessors after performing the information rollups of the specific successors.

Therefore, the present invention provides a computer-implemented method, system and program product for performing branched rollup of shared learning competencies in a learning environment.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative hierarchical tree corresponding to a learning environment.

FIG. 2 depicts the hierarchical tree of FIG. 1 in which two nodes share a learning competency.

FIG. 3 depicts computer system having a branched rollup system according to the present invention.

FIG. 4A depicts method flow diagram according to the present invention.

FIG. 4B continues the method flow diagram of FIG. 4A.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a computer-implemented method, system and program product for performing branched rollup of shared learning competencies in a learning environment. Specifically, under the present invention a hierarchical tree corresponding to the learning environment is provided. When the state of a shared learning competency in the learning environment is changed, branched rollup through the hierarchical tree is performed so that all applicable nodes are rolled up without a node being rolled up more than once. Specifically, when the state of the shared learning competency is changed, control blocks are generated for each predecessor of the “sharing” nodes. The control block for each predecessor identifies the successors (nodes) that must be rolled up before the predecessor itself can be rolled up. Under this methodology, a node will only be rolled up when all necessary successors have been rolled up, thus, preventing repeated rollup of any of the nodes.

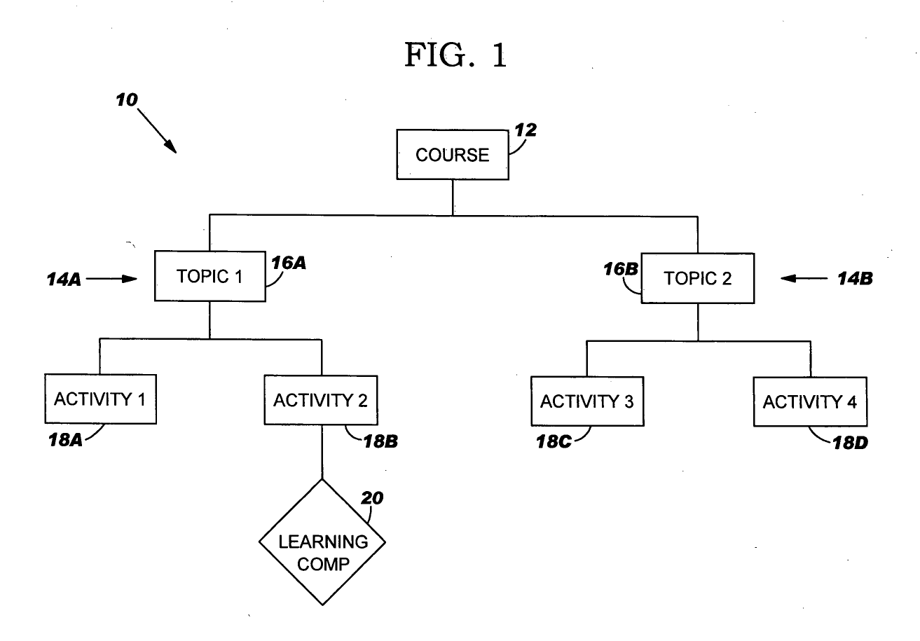

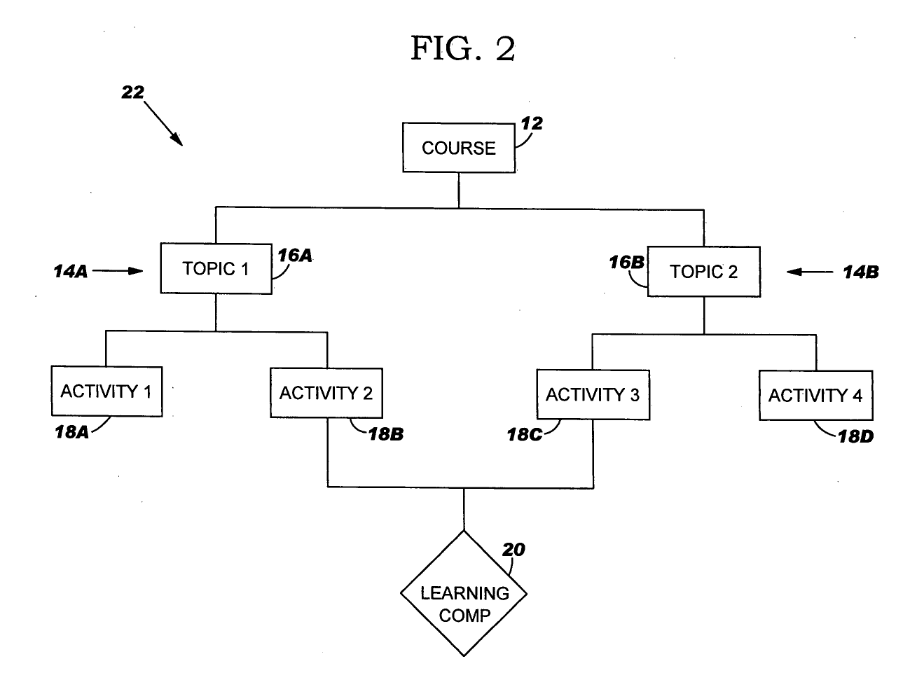

It should be understood that hierarchical trees 10 and 22 shown in FIGS. 1 and 2 are intended to be illustrative only, and that the present invention could be implemented in conjunction with any type of hierarchical tree. For example, although shown as the “root” of trees 10 and 22, parent node 12 could itself have one or more predecessor and/or sibling nodes.

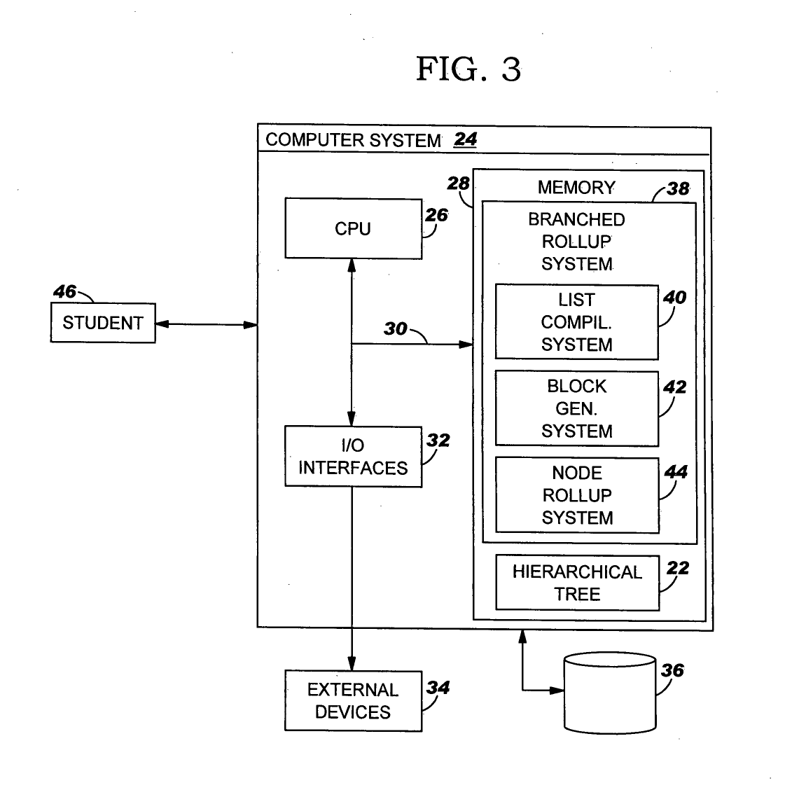

In any event, referring to FIGS. 2 and 3 collectively, the functions of the present invention will be described in greater detail. In general, the present invention allows a complete branched rollup of shared learning competency 20 to occur without node(s) (e.g., parent node 12) having to be rolled up twice. To this extent, a computer system 24 is provided in FIG. 3. Computer system 24 can represent any type of computerized device with which student 46 communicates in a learning environment. For example, computer system 24 could be a stand-alone system that student 46 directly accesses, or a server that student communicates with over a network using a client (not shown). In the case of the latter, the network could be any type of network such as the Internet, a local area network (LAN), a wide area network (WAN), a virtual private network (VPN), etc. As such, communication between the client and computer system 24 could occur via a direct hardwired connection (e.g., serial port), or via an addressable connection that may utilize any combination of wireline and/or wireless transmission methods. The client may utilize conventional network connectivity, such as Token Ring, Ethernet, WiFi or other conventional communications standards. Moreover, connectivity could be provided by conventional TCP/IP sockets-based protocol. In this instance, the client could utilize an Internet service provider to establish connectivity to computer system 24.

In any event, as shown, computer system 24 generally comprises central processing unit (CPU) 26, memory 28, bus 30, input/output (I/O) interfaces 32, external devices/resources 34 and storage unit 36. CPU 26 may comprise a single processing unit, or be distributed across one or more processing units in one or more locations, e.g., on a client and computer system. Memory 28 may comprise any known type of data storage and/or transmission media, including magnetic media, optical media, random access memory (RAM), read-only memory (ROM), a data cache, etc. Moreover, similar to CPU 26, memory 28 may reside at a single physical location, comprising one or more types of data storage, or be distributed across a plurality of physical systems in various forms.

I/O interfaces 32 may comprise any system for exchanging information to/from an external source. External devices/resources 34 may comprise any known type of external device, including speakers, a CRT, LCD screen, handheld device, keyboard, mouse, voice recognition system, speech output system, printer, monitor/display, facsimile, pager, etc. Bus 30 provides a communication link between each of the components in computer system 24 and likewise may comprise any known type of transmission link, including electrical, optical, wireless, etc.

Storage unit 36 can be any system (e.g., database) capable of providing storage for information under the present invention. Such information could include, for example, the hierarchical tree 22, a list of nodes that share learning competency (as described below), etc. As such, storage unit 36 could include one or more storage devices, such as a magnetic disk drive or an optical disk drive. In another embodiment, storage unit 36 includes data distributed across, for example, a local area network (LAN), wide area network (WAN) or a storage area network (SAN) (not shown). Furthermore, although not shown, additional components, such as cache memory, communication systems, system software, etc., may be incorporated into computer system 24. In addition, it should be appreciated that although not shown, any computer system (e.g., client) operated by student 46 would likely include computerized components similar to computer system 24. Such components have not been shown for brevity purposes.

Shown in memory 28 of computer system 24 is branched rollup system 38 and hierarchical tree 22. As further shown, branched rollup system 38 includes list compilation system 40, block generation system 42 and node rollup system 44. Under the present invention, when the state of a shared competency 20 (FIG. 2) changes for a student, branched rollup system 38 will ensure that all appropriate nodes of hierarchical tree 22 are rolled up a single time. This is generally accomplished with a multi-pass (e.g., 2-pass) algorithm through hierarchical tree 22. Specifically, assume that shared learning competency 20 represents a mastery of a “billing module” of a software program. Further assume that the state of shared learning competency 20 changes when student 46 completes “Activity 2” of grandchild node 18B. In this instance, the state of shared learning competency 20 should also be changed accordingly with respect to “Activity 3” of grandchild node 18C.

Under the present invention, upon a change in the state of shared learning competency 20, a first pass will be made through hierarchical tree 22. During this first pass, list compilation system 40 will analyze hierarchical tree 22 and identify all nodes that share learning competency 20 with grandchild node 18B and/or are affected by its status. In this case, grandchild node 18C will be identified. Once identified, all such nodes will be placed in a list of nodes. Thereafter, block generation system 42 will generate and associate control blocks with all predecessors of grandchild nodes 18B-C that will require information rollup based on a change in the state of shared learning competency 20. In viewing hierarchical diagram 22, it can be seen when shared learning competency 20 is changed for grandchild node 18B, an information rollup for child nodes 16A-B as well as parent node 12 must be performed. In general, each control block is a data structure that identifies the successor nodes that must be rolled up before particular predecessor can be rolled up. For example, the control block for child node 16A will identify grandchild node 18B, the control block for child node 16B will identify grandchild node 18B, while the control block for parent node 12 will identify both child nodes 16A-B.

Once the control blocks have been generated, the second pass through hierarchical tree 22 can be conducted. During this pass, node rollup system 44 will attempt to process the control blocks and perform the information rollups. Specifically, each time a control block is completely processed (i.e., all identified successors have been rolled up), node rollup system 44 will then perform the information rollup of the node corresponding to that control block. To this extent, the information rollup process will begin with the grandchild node 18B for which shared learning competency 20 was originally changed (i.e., the rollup target). The information rollup process will then proceed up the corresponding branch 14A of hierarchical tree 22. Specifically, node roll up system 44 will process the control block for child node 16A. Since information rollup of child node 16A is dependent only on information rollup of grandchild node 18B, the control block is processed completely and node rollup system 44 will perform the information rollup of child node 16A. However, upon then reaching parent node 12, it will be recognized by node rollup system 44 that the control block corresponding thereto cannot be completely processed. Specifically, the control block for parent node 12 requires that both child nodes 16A-B be rolled up before parent node 12 can itself be rolled up. Accordingly, the information rollup of parent node 12 will be delayed.

At this point, node rollup system 44 will consult the list of nodes to identify the other node(s) and corresponding branch(es) of hierarchical tree 22 that should be rolled up so that parent node 12 can eventually be rolled up. In consulting this list, grandchild node 18C will be identified. Accordingly, node rollup system 44 will repeat its functions for branch 14B. Specifically, information rollup grandchild node 18C will be performed. At this point, the control block corresponding to child node 16B can be completely processed, and information rollup of child node 16B can be performed. Once the information rollup of child node 16B has been performed, the control block for parent node 12 can be completely processed (i.e., because information rollup for both child nodes 16A-B have been performed at this point). Thereafter, node rollup system 44 will perform the information rollup of parent node 12.

As can be seen, the present invention thus allows branched rollup to occur without having to rollup the same node multiple times. It should be noted that if learning competency 20 was shared by grandchild node 18A as well as grandchild nodes 18B-C, child node 16A would not be rolled up until information rollup had occurred for both grandchild nodes 18A-B. In any event, in a typical embodiment, the rollup process as performed by node rollup system 44 is accomplished by maintaining a rollup cursor or the like as the rollup process progressed through branches 14A-B. Specifically, node rollup system 44 initially maintains a cursor at grandchild node 18B (i.e., the rollup target) when the rollup process commences. As the cursor moves to child node 16A, the control block corresponding thereto is processed. The same technique is employed when rolling up nodes in branch 14B.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

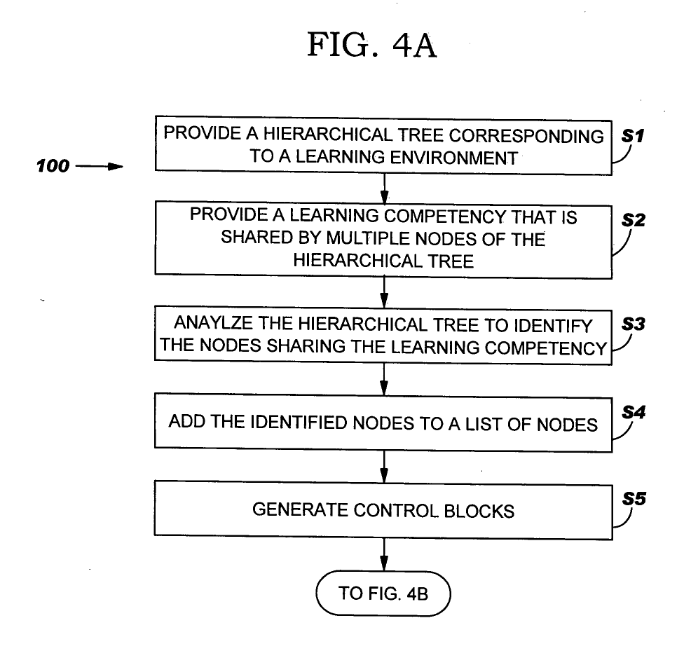

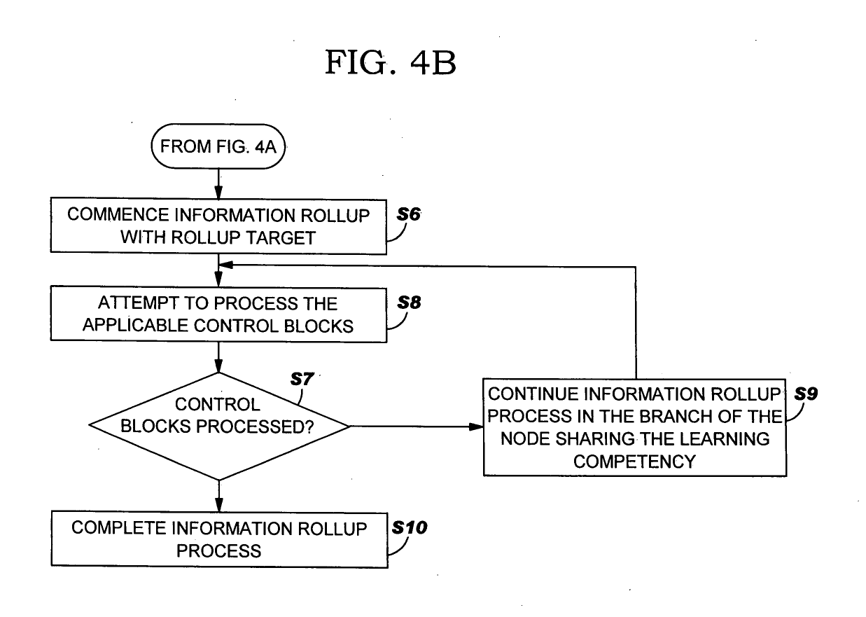

Referring now to FIGS. 4A-B, a method flow diagram 100 according to the present invention. As depicted in FIG. 4A, first step S1 of method 100 is to provide a hierarchical tree corresponding to a learning environment. Second step S2 is to provide a learning competency that is shared by multiple nodes of the hierarchical tree. Third step S3 is to analyze the hierarchical tree to identify the nodes that share the learning competency upon a change in the state thereof. Fourth step S4 is to add the identified nodes to a list of nodes. Fifth step S5 is to generate control blocks for applicable predecessors of the nodes that share the learning competency. The process is continued in FIG. 4B with sixth step S6 by commencing the information rollup process with the rollup target. Seventh step S7 is attempt to continue the rollup process up the branch of the hierarchical tree corresponding to the rollup target by processing the control blocks of the predecessors. In eighth step S8, it is determined whether a control block of a predecessor has been completely processed. If not, in ninth step S9, the list is consulted, and the rollup process is continued with the next node that shares the learning competency. Once all necessary control blocks have been completely processed in step S8, the information rollup process is completed in step S10.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the depiction of branched rollup system 38 of FIG. 3 is intended to be illustrative only. To this extent, the functions described herein could be implemented in a different quantity of subsystems. For example, separate subsystems could be provided to process control blocks and perform the information rollups.

1. A computer-implemented method for performing branched rollup for shared learning competencies in a learning environment, comprising:
providing a hierarchical tree corresponding to the learning environment, wherein the hierarchical tree includes a parent node, a first branch having a first child node and a first grandchild node, and a second branch having a second child node and a second grandchild node;
providing a learning competency in the learning environment that is shared by the first grandchild node and the second grandchild node;
performing an information rollup of the first child node upon a change in state of the learning competency, and performing an information rollup of the second child node after performing the information rollup of the first child node; and
performing an information rollup of the parent node only after performing the information rollup of the first child node and the information rollup of the second child node.

2. The computer-implemented method of claim 1, further comprising:
analyzing the hierarchical tree to identify the second grandchild node as sharing the learning competency with the second grandchild node; and
adding the second grandchild node to a list of nodes prior to performing the information rollup of the first child node.

3. The computer-implemented method of claim 2, further comprising consulting the list of nodes prior to performing the information rollup of the second child node.

4. The computer-implemented method of claim 1, further comprising generating a control block for each of the first child node, the second child node and the parent node prior to the first performing step, wherein the control block for the parent node indicates that the information rollup of the first child node and the information rollup of second child node must both be performed prior to performing the information rollup of the parent node.

5. The method of claim 4, further comprising:
processing the control block for the first child node prior to performing the information rollup of the first child node;
processing the control block for the second child node prior to performing the information rollup of the second child node; and
processing the control block for the parent node prior to performing the information rollup of the parent node.

6. The computer-implemented method of claim 1, wherein the learning environment is implemented in a computerized environment.

7. A computerized system for performing branched rollup for shared learning competencies in a learning environment, comprising:
a list compilation system for generating a list of nodes that share a learning competency within a hierarchical tree corresponding to the learning environment;
a block generation system for generating control blocks for predecessors of the nodes in the list of nodes, wherein each of the control blocks identifies specific successors of the predecessors for which information rollups must be performed before information rollups of the predecessors can be performed; and
a node rollup system for processing the control blocks and performing the information rollups of the predecessors after performing the information rollups of the specific successors.

8. The computerized system of claim 7, wherein the hierarchical tree comprises a parent node, a first branch having a first child node and a first grandchild node, and a second branch having a second child node and a second grandchild node.

9. The computerized system of claim 8, wherein the learning competency is shared by the first grandchild node and the second grandchild node, wherein the first child node and the parent node are the predecessors of the first grandchild node, and wherein the second child node and the parent node are the predecessors of the second grandchild node.

10. The computerized system of claim 9, wherein the information rollup of the parent node is performed only after the information rollup of the first child node and the information rollup of the second child node are performed.

11. The computerized system of claim 7, wherein the learning environment is implemented in a computerized environment.

12. The computerized system of claim 7, wherein the information rollups of the first child node, the second child node and the parent node are performed a maximum of one time for a change in state of the learning competency.

13. The computerized system of claim 7, wherein the list of nodes is generated, the control blocks are generated and processed, and the information rollups are performed upon a change in state of the learning competency.

14. A computer program product stored on a recordable medium for performing branched rollup for shared learning competencies in a learning environment, which when executed, comprises:
program code for generating a list of nodes that share a learning competency within a hierarchical tree corresponding to the learning environment;
program code for generating control blocks for predecessors of the nodes in the list of nodes, wherein each of the control blocks identifies specific successors of the predecessors for which information rollups must be performed before information rollups of the predecessors can be performed; and
program code for processing the control blocks and performing the information rollups of the predecessors after performing the information rollups of the specific successors.

15. The computer program product of claim 14, wherein the hierarchical tree comprises a parent node, a first branch having a first child node and a first grandchild node, and a second branch having a second child node and a second grandchild node.

16. The computer program product of claim 15, wherein the learning competency is shared by the first grandchild node and the second grandchild node, wherein the first child node and the parent node are the predecessors of the first grandchild node, and wherein the second child node and the parent node are the predecessors of the second grandchild node.

17. The computer program product of claim 16, wherein the information rollup of the parent node is performed only after the information rollup of the first child node and the information rollup of the second child node are performed.

18. The computer program product of claim 14, wherein the learning environment is implemented in a computerized environment.

19. The computer program product of claim 14, wherein the information rollups of the first child node, the second child node and the parent node are performed a maximum of one time for a change in state of the learning competency.

20. The computer program product of claim 14, wherein the list of nodes is generated, the control blocks are generated and processed, and the information rollups are performed upon a change in the state of the learning competency.
